(19) United States
(12) Patent Application Publication
(10) Pub. No.: US 2025/0379227 A1
(43) Pub. Date: Dec. 11, 2025

(54) ELECTRODES HAVING ELECTROLYTE ADDITIVES AND ELECTROCHEMICAL CELLS COMPRISING THE ELECTRODES

(71) Applicant: GM GLOBAL TECHNOLOGY OPERATIONS LLC, Detroit, MI (US)

(72) Inventors: Vamakshi Yadav, Sterling Heights, MI (US); Lei Wang, Rochester Hills, MI (US); Raneen Taha, Sterling Heights, MI (US)

(73) Assignee: GM GLOBAL TECHNOLOGY OPERATIONS LLC, Detroit, MI (US)

(21) Appl. No.: 18/736,458

(22) Filed: Jun. 6, 2024

(51) Int. Cl. H01M 4/505; H01M 4/02; H01M 10/0525; H01M 10/0567; H01M 10/0569

(52) U.S. Cl. CPC H01M 4/505; H01M 10/0525; H01M 10/0567; H01M 10/0569; H01M 2004/028; H01M 2220/20; H01M 2300/0034; H01M 2300/0037

(57) ABSTRACT

Electrodes having electrolyte additives and electrochemical cells that cycle lithium ions and include the electrodes are provided. The electrodes include a lithium-rich, manganese-rich layered oxide electroactive material, and an electrolyte including two or more electrolyte additives selected from the group consisting of: a lithium salt additive, a fluorinated ester-based additive, a silicon-based additive, and combinations thereof.

### INTRODUCTION

The technical field generally relates to electrochemical cells, and more particularly relates to electrochemical cells having one or more electrolyte additives configured to reduce unintended gas generation.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or a solid-state separator), the solid-state electrolyte (or the solid-state separator) may physically separate the electrodes so that a distinct separator is not required.

Many different materials may be used to create components for a lithium-ion battery. For example, in various aspects, positive electrodes may include lithium-rich, manganese-rich layered oxide electroactive materials, such as xLi₂MnO₃·(1−x)LiMO₂ or Li_{1+y}M_{1-y}O₂(M=Mn, Ni, Co, etc., 0<x<1, 0<y≤0.33), which are capable of providing improved capacity capability (e.g., greater than about 200 mAh/g) at high operating voltages (e.g., greater than about 3.5 V). Such materials, however, are often susceptible to detrimental reactions at the cathode-electrolyte interface, such as gas generation.

Accordingly, it is desirable to develop improved battery materials that can address these challenges. Furthermore, other desirable features and characteristics of the present disclosure will become apparent from the subsequent detailed description and the appended claims, taken in conjunction with the accompanying drawings and the foregoing introduction.

### SUMMARY

An electrode is provided for an electrochemical cell that cycles lithium ions. In one examples, the electrode includes a lithium-rich, manganese-rich layered oxide electroactive material, and an electrolyte including two or more electrolyte additives selected from the group consisting of: a lithium salt additive, a fluorinated ester-based additive, a silicon-based additive, and combinations thereof.

In various examples, the electrode may include greater than or equal to about 0.001 wt. % to less than or equal to about 10 wt. % of each of the two or more electrolyte additives.

In various examples, the electrolyte may include diethyl carbonate and fluoroethylene carbonate.

In various examples, the two or more electrolyte additives, in combination, may include phosphorus, silicon, and fluorine.

In various examples, the two or more electrolyte additives include tris(trimethylsilyl) phosphite (TTMSPi) and lithium difluorophosphate (LiPO₂F₂).

In various examples, the two or more electrolyte additives may include 2,2,2-trifluoroethyl acetate (TFEA), lithium bis(trifluoromethanesulfonyl)imide (LiTFSI), tris(trimethylsilyl) phosphite (TTMSPi), and lithium difluorophosphate (LiPO₂F₂). In various examples, the two or more electrolyte additives include 0.1 to 5.0 wt. % TFEA, 0.1 to 5.0 wt. % LiTFSI, 0.1 to 5.0 wt. % TTMSPi, and 0.1 to 5.0 wt. % LiPO₂F₂.

In various examples, the two or more electrolyte additives may provide a synergistic effect that in combination is configured to reduce gas production within the electrochemical cell.

An electrochemical cell that cycles lithium ions is provided that, in one examples, includes a first electrode having a first polarity and including a positive, lithium-rich, manganese-rich layered oxide electroactive material, and an electrolyte including two or more electrolyte additives selected form the group consisting of: a lithium salt additive, a fluorinated ester-based additive, a silicon-based additive, and combinations thereof, a second electrode having a second polarity opposite from the first polarity and including a negative electroactive material, and a separating layer disposed between the first electrode and the second electrode.

In various examples, the first electrode of the electrochemical cell may include greater than or equal to about 0.001 wt. % to less than or equal to about 10 wt. % of each of the two or more electrolyte additives.

In various examples, the electrolyte of the electrochemical cell may include diethyl carbonate and fluoroethylene carbonate.

In various examples, the two or more electrolyte additives of the electrochemical cell, in combination, may include phosphorus, silicon, and fluorine.

In various examples, the two or more electrolyte additives of the electrochemical cell may include tris(trimethylsilyl) phosphite (TTMSPi) and lithium difluorophosphate (LiPO₂F₂).

In various examples, the two or more electrolyte additives of the electrochemical cell may include 2,2,2-trifluoroethyl acetate (TFEA), lithium bis(trifluoromethanesulfonyl)imide (LiTFSI), tris(trimethylsilyl) phosphite (TTMSPi), and lithium difluorophosphate (LiPO₂F₂). In various examples, the two or more electrolyte additives include 0.1 to 5.0 wt. % TFEA, 0.1 to 5.0 wt. % LiTFSI, 0.1 to 5.0 wt. % TTMSPi, and 0.1 to 5.0 wt. % LiPO₂F₂.

In various examples, at least one of the two or more electrolyte additives of the electrochemical cell may include at least one fluorinated ester-based additive.

A vehicle is provided that, in one example, includes a propulsion system that includes an electric motor, and an electrochemical cell that cycles lithium ions and is configured to provide electrical power to the electric motor. The electrochemical cell includes a first electrode having a first polarity and including a positive, lithium-rich, manganese-rich layered oxide electroactive material represented by xLi₂MnO₃·(1−x)LiMO₂ where M is a transition metal selected from the group consisting of: nickel (Ni), manganese (Mn), cobalt (Co), aluminum (Al), iron (Fe), and combinations thereof, and 0.01≤x≤0.99, and an electrolyte including two or more electrolyte additives selected form the group consisting of: a lithium salt additive, a fluorinated ester-based additive, a silicon-based additive, and combinations thereof, wherein the electrolyte comprises greater than or equal to about 0.001 wt. % to less than or equal to about 10 wt. % of each of the two or more electrolyte additives, a second electrode having a second polarity opposite from the first polarity and comprising a negative electroactive material, and a separating layer disposed between the first electrode and the second electrode.

In various examples, the two or more electrolyte additives of the vehicle may include tris(trimethylsilyl) phosphite (TTMSPi) and lithium difluorophosphate (LiPO₂F₂).

In various examples, the two or more electrolyte additives of the vehicle may include 2,2,2-trifluoroethyl acetate (TFEA), lithium bis(trifluoromethanesulfonyl)imide (LiTFSI), tris(trimethylsilyl) phosphite (TTMSPi), and lithium difluorophosphate (LiPO₂F₂). In various examples, the two or more electrolyte additives may include 0.1 to 5.0 wt. % TFEA, 0.1 to 5.0 wt. % LiTFSI, 0.1 to 5.0 wt. % TTMSPi, and 0.1 to 5.0 wt. % LiPO₂F₂.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic of an exemplary electrochemical cell including two or more electrochemical additives in accordance with an example;

FIG. 2 is a bar graph representing gas generation within exemplary electrochemical cells in accordance with an example;

FIG. 3 is a graph representing discharge capacity and discharge capacity retention of exemplary electrochemical cells in accordance with an example;

FIGS. 4 and 5 are graphs representing discharge capacity and discharge capacity retention, respectively, of exemplary electrochemical cells in accordance with an example; and

FIG. 6 is a functional block diagram representing a vehicle having an exemplary electrochemical cell including two or more electrochemical additives in accordance with an example.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

Systems and methods disclosed herein provide for electrochemical cells including one or more electrolyte additives, and to methods of forming and using the electrochemical cells. The cells can be used in vehicle or automotive transportation applications (e.g., motorcycles, boats, tractors, buses, motorcycles, mobile homes, campers, and tanks). However, the systems and methods disclosed herein may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of nonlimiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

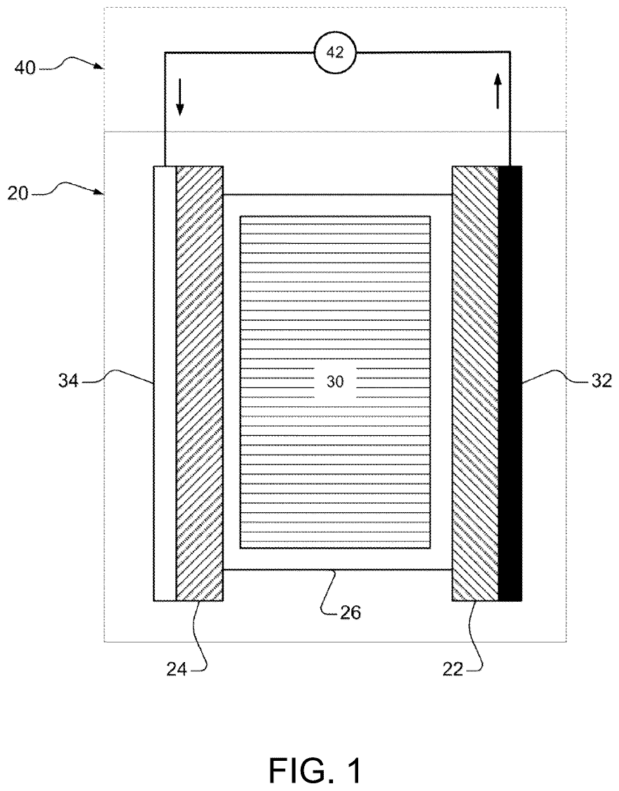

An exemplary and schematic illustration of an electrochemical cell (also referred to as a battery) 20 is shown in FIG. 1. The cell 20 includes a negative electrode 22 (e.g., anode), a positive electrode 24 (e.g., cathode), and a separator 26 disposed between the two electrodes 22, 24. The separator 26 provides electrical separation and prevents physical contact between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, in certain variations, negative electrodes 22 (also referred to as negative electroactive material layers) may be disposed on one or more parallel sides of the first current collector 32. Similarly, in other variations, a negative electroactive material layer may be disposed on a first side of the first current collector 32, and a positive electroactive material layer may be disposed on a second side of the first current collector 32. In each instance, the first current collector 32 may be a metal foil, metal grid or screen, or expanded metal comprising copper or any other appropriate electrically conductive material.

A second current collector 34 (e.g., a positive current collector) may be positioned at or near the positive electrode 24. The second current collector 34 together with the positive electrode 24 may be referred to as a positive electrode assembly. Although not illustrated, in certain variations, positive electrodes 24 (also referred to as positive electroactive material layers) may be disposed on one or more parallel sides of the second current collector 34. Similarly, in other variations, a positive electroactive material layer may be disposed on a first side of the second current collector 34, and a negative electroactive material layer may be disposed on a second side of the second current collector 34. In each instance, the second current collector 34 may be a metal foil, metal grid or screen, or expanded metal comprising aluminum or any other appropriate electrically conductive material.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The cell 20 can generate an electric current during discharge by way of reversible electrochemical reactions that occur when the external circuit 40 is closed (to connect the negative electrode 22 and the positive electrode 24) and the negative electrode 22 has a lower potential than the positive electrode 24. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the cell 20 is diminished.

The cell 20 can be charged or re-energized at any time by connecting an external power source to the cell 20 to reverse the electrochemical reactions that occur during battery discharge. Connecting an external electrical energy source to the cell 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the cell 20 may vary depending on the size, construction, and particular end-use of the cell 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the cell 20 may also include a variety of other components including, for example, a casing, gaskets, terminal caps, tabs, battery terminals, and any other conventional components or materials that may be situated within the cell 20, including between or around the negative electrode 22, the positive electrode 24, and/or the separator 26. The cell 20 shown in FIG. 1 includes a liquid electrolyte 30 and shows representative concepts of battery operation. However, the present technology also applies to solid-state batteries and/or semi-solid-state batteries that include solid-state electrolytes and/or solid-state electrolyte particles and/or semi-solid electrolytes and/or solid-state electroactive particles that may have different designs.

The size and shape of the cell 20 may vary depending on the particular application for which it is designed. Battery-powered vehicles and hand-held consumer electronic devices, for example, are two examples where the cell 20 would most likely be designed to different size, capacity, and power-output specifications. The cell 20 may also be connected in series or parallel with other similar lithium-ion cells or batteries to produce a greater voltage output, energy, and power if it is required by the load device 42. Accordingly, the cell 20 can generate electric current to a load device 42 that is part of the external circuit 40. The load device 42 may be powered by the electric current passing through the external circuit 40 when the cell 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the cell 20 for purposes of storing electrical energy.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be mixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. In some examples, the ceramic material may be selected from the group consisting of: alumina (Al₂O₃), silica (SiO₂), and combinations thereof. In some examples, the heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In some examples, the separator 26 may have an average thickness greater than or equal to about 1 μm to less than or equal to about 50 μm, and in certain instances, optionally greater than or equal to about 1 μm to less than or equal to about 25 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S, Li2ₛ—P₂S₅, Li₆PS₅Cl, Li₆PS₅Br, Li₆PS₅I, Li₃OCl, Li_{2.99}Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22. In each instance, the solid-state electrolyte and/or semi-solid-state electrolyte includes the electrolyte additive as detailed above.

The negative electrode 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers to define the three-dimensional structure of the negative electrode 22. The electrolyte 30 may be introduced, for example after cell assembly, and contained within pores of the negative electrode 22. For example, in certain variations, the negative electrode 22 may include a plurality of solid-state electrolyte particles. In some examples, the negative electrode 22 (including the one or more layers) may have a thickness greater than or equal to about 0 nm to less than or equal to about 500 μm, optionally greater than or equal to about 1 μm to less than or equal to about 500 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. For example, in certain variations, the negative electrode 22 may be defined by a lithium metal foil. In other variations, the negative electrode 22 may include, for example only, carbonaceous materials (such as, graphite, hard carbon, soft carbon, and the like) and/or metallic active materials (such as tin, aluminum, magnesium, germanium, and alloys thereof, and the like). In further variations, the negative electrode 22 may include a silicon-based electroactive material. In still further variations, the negative electrode 22 may be a composite electrode including a combination of negative electroactive materials. For example, the negative electrode 22 may include a first negative electroactive material and a second negative electroactive material. In certain variations, a ratio of the first negative electroactive material to the second negative electroactive material may be greater than or equal to about 5:95 to less than or equal to about 95:5. The first negative electroactive material may be a volume-expanding material including, for example, silicon, aluminum, germanium, and/or tin. The second negative electroactive material may include a carbonaceous material (e.g., graphite, hard carbon, and/or soft carbon) For example, in certain variations, the negative electroactive material may include a carbonaceous-silicon based composite including, for example, about 10 wt. % SiOₓ (where 0≤x≤2) and about 90 wt. % graphite. In some examples, the negative electroactive material may be prelithiated.

In certain variations, the negative electroactive material may be optionally intermingled (e.g., slurry casted) with an electronically conductive material (i.e., conductive additive) that provide an electron conductive path and/or a polymeric binder material that improve the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrenebutadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (e.g., SuperP (SP)), and the like. Examples of a conductive polymer include polyaniline, polythiophene, polyacetylene, polypyrrole, and the like.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In some examples, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electrode 24 may be a lithium-rich layered cathode including a positive electroactive material represented by: xLi₂MnO₃·(1-x)LiMO₂ where M are transitions metals (for example, independently selected from the group consisting of: nickel (Ni), manganese (Mn), cobalt (Co), aluminum (Al), iron (Fe), and combinations thereof, and where 0.01≤x≤0.99. In other variations, the positive electrode 24 may be a layered oxide represented by LiMeO₂, where Me is a transition metal, such as cobalt (Co), nickel (Ni), manganese (Mn), iron (Fe), aluminum (Al), vanadium (V), or combinations thereof. For example, the positive electrode 24 may include Li_{1.2}Ni_{0.12}Co_{0.12}Mn_{0.56}O₂ and/or Li_{1.2}Ni_{0.24}Mn_{0.56}O₂.

In other variations, the positive electrode 24 may be a composite electrode including two or more positive electroactive materials. For example, the positive electrode 24 may include a first positive electroactive material and a second positive electroactive material. In certain variations, a ratio of the first positive electroactive material to the second positive electroactive material may be greater than or equal to about 1:9 to less than or equal to about 9:1. The first positive electroactive material may include the lithium-rich, layered positive electroactive material. The second positive electrode material may include, for example, an olivine-type oxide represented by LiMePO₄, where Me is a transition metal, such as cobalt (Co), nickel (Ni), manganese (Mn), iron (Fe), aluminum (Al), vanadium (V), or combinations thereof; a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof; a spinel-type oxide represented by LiMe₂O₄, where Me is a transition metal, such as cobalt (Co), nickel (Ni), manganese (Mn), iron (Fe), aluminum (Al), vanadium (V), or combinations thereof; a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof; and/or combinations thereof.

In some examples, the positive electroactive material may be optionally intermingled (e.g., slurry casted) with an electronically conductive material (i.e., conductive additive) that provide an electron conductive path and/or a polymeric binder material that improve the structural integrity of the positive electrode 24. For example, the positive electrode 24 may include greater than or equal to about 30 wt. % to less than or equal to about 98 wt. %, and in certain aspects, optionally greater than or equal to about 60 wt. % to less than or equal to about 97 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder. The conductive additive and/or binder material included in the positive electrode 24 may be the same as or different from the conductive additive as included in the negative electrode 22. In each variation, the cell 20 may have a negative electrode capacity for lithium to positive electrode capacity for lithium (N/P) ratio greater than or equal to about 1 to less than or equal to about 3.

Referring again to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the cell 20.

In certain aspects, the electrolyte 30 may be a non-aqueous liquid electrolyte solution (e.g., >1 M) that includes a lithium salt dissolved in an organic solvent or a mixture of organic solvents. Numerous conventional nonaqueous liquid electrolyte 30 solutions may be employed in the cell 20. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂)(Li—BOB), lithium difluorooxalatoborate (LiBFiC₂O₄)), lithium hexafluoroarsenate (LiAsF₆), lithium trifluoromethanesulfonate (LiCF₃SO₃), lithium bis(trifluoromethane) sulfonylimide (LiN(CF₃SO₂)₂), lithium bis(fluorosulfonyl) imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), y-lactones (e.g., y-butyrolactone, y-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

In various aspects, the electrolyte 30 may include a mixture of solvents. The electrolyte 30 may include a first solvent, a second solvent, and a third solvent. For example, the electrolyte 30 may include greater than or equal to about 10 wt. % to less than or equal to about 80 wt. %, and in certain aspects, optionally greater than or equal to about 20 wt. % to less than or equal to about 33 wt. %, of a first solvent; greater than or equal to about 10 wt. % to less than or equal to about 80 wt. %, and in certain aspects, optionally greater than or equal to about 20 wt. % to less than or equal to about 33 wt. %, of a second solvent; and greater than or equal to about 10 wt. % to less than or equal to about 80 wt. %, and in certain aspects, optionally greater than or equal to about 20 wt. % to less than or equal to about 33 wt. %, of a third solvent. In certain variations, the solvents may be independently selected from the group consisting of: ethylene carbonate (EC), fluoroethylene carbonate (FEC), dimethyl carbonate (DMC), diethyl carbonate (DEC), ethylmethylcarbonate (EMC), and combinations thereof.

In various examples, the electrolyte 30 includes one or more electrolyte additives that promote improved cycling stability and/or to mitigate gas generation. For example, the electrolyte 30 may include one or more electrolyte additives each having a concentration of greater than or equal to about 0.001 wt. % to less than or equal to about 10 wt. %, such as greater than or equal to about 0.1 wt. % to less than or equal to about 7 wt. %, such as greater than or equal to about 0.1 wt. % to less than or equal to about 6 wt. %, such as greater than or equal to about 0.1 wt. % to less than or equal to about 5 wt. %, such as greater than or equal to about 0.1 wt. % to less than or equal to about 4 wt. %, such as greater than or equal to about 0.1 wt. % to less than or equal to about 3 wt. %, such as greater than or equal to about 0.1 wt. % to less than or equal to about 2 wt. %, such as greater than or equal to about 0.1 wt. % to less than or equal to about 1 wt. %.

In various examples, the electrolyte 30 may include one or more lithium salt additives, one or more silicon-based additives, one or more fluorinated ester-based additives, or a combination thereof.

In some examples, the electrolyte 30 may include one or more lithium salt additives such as, for example, lithium hexafluorophosphate (LiPF₆), lithium perchlorate (LiClO₄), lithium tetrafluoroborate (LiBF₄), lithium hexafluoroarsenate (LiAsF₆), lithium bis(trifluoromethanesulfonyl)imide (LiTFSI), lithium bis(fluorosulfonyl)imide (LiFSI), lithium difluoro(oxalato)borate (LiDFOB), lithium bis(oxalato)borate (LiBOB), and lithium difluorophosphate (LiPO₂F₂). In various examples, the electrolyte 30 may include one or more lithium salt additives each having a concentration of greater than or equal to about 0.1 M to less than or equal to about 3 M, such as greater than or equal to about 0.1 M to less than or equal to about 2 M.

In some examples, the electrolyte 30 may include one or more fluorinated ester-based additives such as, for example, 2,2,2-trifluoroethyl acetate (TFEA), methyl pentafluoropropionate (MTFP), methyl 3,3,3-trifluoropropionate (MPFP), and 2,2,2-trifluoroethyl butyrate (TFEB). In various examples, the electrolyte 30 may include one or more fluorinated ester-based additives each having a concentration of greater than or equal to about 0.1 wt. % to less than or equal to about 10 wt. %, such as greater than or equal to about 1.0 wt. % to less than or equal to about 5 wt. %.

In some examples, the electrolyte 30 may include one or more silicon-based additives such as, for example, tris(trimethylsilyl) phosphite (TTMSPi), tris(trimethylsilyl) phosphate (TTMSP), and tris(trimethylsilyl)borate (TTMSB). In various examples, the electrolyte 30 may include one or more silicon-based additives each having a concentration of greater than or equal to about 0.1 wt. % to less than or equal to about 10 wt. %, such as greater than or equal to about 1.0 wt. % to less than or equal to about 5 wt. %, such as greater than or equal to about 0.1 wt. % to less than or equal to about 2 wt. %, such as greater than or equal to about 0.1 wt. % to less than or equal to about 1 wt. %.

In various examples, the electrolyte 30 may include TTMSPi and LiPO₂F₂ as electrolyte additives. For example, the electrolyte 30 may include, as electrolyte additives, greater than or equal to about 0.1 wt. % to less than or equal to about 5.0 wt. % TTMSPi and greater than or equal to about 0.1 wt. % to less than or equal to about 5.0 wt. % LiPO₂F₂, such as greater than or equal to about 0.1 wt. % to less than or equal to about 1.0 wt. % TTMSPi and greater than or equal to about 0.1 wt. % to less than or equal to about 1.0 wt. % LiPO₂F₂

In various examples, the electrolyte 30 may include TFEA, LiTFSI, TTMSPi and LiPO₂F₂ as electrolyte additives. For example, the electrolyte 30 may include, as electrolyte additives, greater than or equal to about 1.0 wt. % to less than or equal to about 5.0 wt. % TFEA, greater than or equal to about 0.1 wt. % to less than or equal to about 5.0 wt. % LiTFSI, greater than or equal to about 0.1 wt. % to less than or equal to about 5.0 wt. % TTMSPi, and greater than or equal to about 0.1 wt. % to less than or equal to about 5.0 wt. % LiPO₂F₂, such as greater than or equal to about 1.0 wt. % to less than or equal to about 5.0 wt. % TFEA, greater than or equal to about 0.1 wt. % to less than or equal to about 1.0 wt. % LiTFSI, greater than or equal to about 0.1 wt. % to less than or equal to about 1.0 wt. % TTMSPi, and greater than or equal to about 0.1 wt. % to less than or equal to about 1.0 wt. % LiPO₂F₂.

In various examples, the electrolyte 30 may have a combination of two or more electrolyte additives, such as a combination of any of the electrolyte additives noted previously, that in combination provide a synergistic effect to substantially reduce gas generation within the cell 20, for example, by reducing the likelihood of gas generating reactions at the cathode-electrolyte interface. In various examples, the synergistic effect provides a greater reduction in gas generation within the cell 20 than a combined total reduction in gas generation than each of the electrolyte additives when used independently. While not intending to be limited to any theory, it was determined during investigations leading to aspects of the systems and methods disclosed herein that certain combinations of electrolyte additives that include all three of phosphorus, silicon, and fluorine may provide a synergistic effect that substantially reduces gas generation within a lithium- and manganese-rich layered oxide electrochemical cell. In some examples, the electrolyte additives, in combination, reduce gas generation within the cell 20 (relative to the cell 20 not including the electrolyte additives) of equal to or greater than 5%, such as equal to or greater than 10%, such as equal to or greater than 15%, such as equal to or greater than 20%, such as equal to or greater than 25%, such as equal to or greater than 30%, such as equal to or greater than 35%, such as equal to or greater than 40%, such as equal to or greater than 45%, such as equal to or greater than 50%.

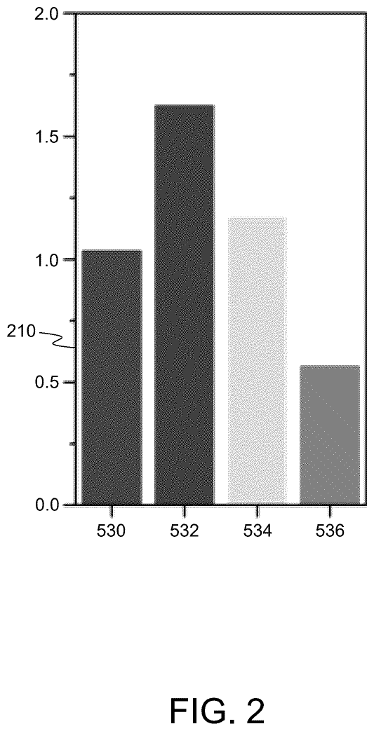

FIGS. 2-5 include graphs representing data obtained during experiments performed while investigating certain aspects of the present disclosure. In these experiments, coin cells were tested that included electrolytes alone, or including one or more of the electrolyte additives discussed herein. The coin cells comprised a cathode that included a lithium-rich, manganese-rich layered oxide electroactive material, carbon black (CB), and PVDF, and an anode that included an SiOx-graphite composite. The coin cells had an N/P ratio of about 1.07. The coin cells were cycled using a voltage window of 2.0 to 4.6 V. The coin cells further included an electrolyte that included a combination of fluoroethylene carbonate and diethyl carbonate.

FIG. 2 includes a graph showing gas generation (mbar/cycle; axis 210) in the coin cells during cycling. The data represents the electrolyte with: no electrolyte additive (labeled 530); 1.0 wt. % TTMSPi (labeled 532); 1.0 wt. % LiPO₂F₂ (labeled 534); and 1.0 wt. % TTMSPi and 1.0 wt. % LiPO₂F₂ (labeled 536). The results of these experiments indicated that the addition of either TTMSPi or LiPO₂F₂ individually produced an increase in gas generation relative to the baseline electrolyte. In contrast, the addition of both TTMSPi and LiPO₂F₂ in combination had an unexpected synergistic effect that produced a significant decrease in gas generation relative to the baseline electrolyte.

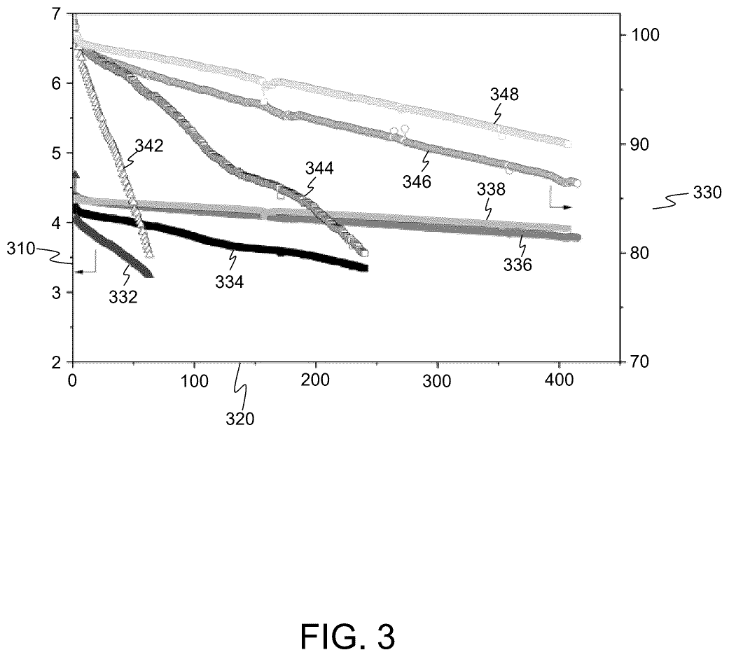

FIG. 3 includes a graph showing discharge capacity (mAh/cm²; axis 310) and discharge capacity retention (%; axis 330) for the coin cells relative to cycle number (axis 320). For the discharge capacity data, the electrolyte included: no electrolyte additive (labeled 332); 1.0 wt. % TTMSPi (labeled 334); 1.0 wt. % TTMSPi and 1.0 wt. % LiPO₂F₂ (labeled 336); and 1.0 wt. % TTMSPi, 1.0 wt. % LiPO₂F₂, 1.0 wt. % LiTFSI, and 5.0 wt. % TFEA (labeled 338). For the discharge capacity retention data, the electrolyte included: no electrolyte additive (labeled 342); 1.0 wt. % TTMSPi (labeled 344); 1.0 wt. % TTMSPi and 1.0 wt. % LiPO₂F₂ (labeled 346); and 1.0 wt. % TTMSPi, 1.0 wt. % LiPO₂F₂, 1.0 wt. % LiTFSI, and 5.0 wt. % TFEA (labeled 348). The results of these experiments indicated that addition of both TTMSPi and LiPO₂F₂ as electrolyte additives, all of TTMSPi, LiPO₂F₂, LiTFSI, and TFEA as electrolyte additives, produced a significant increase in discharge capacity retention, at least in part due to the synergistic effect that decreased gas generation.

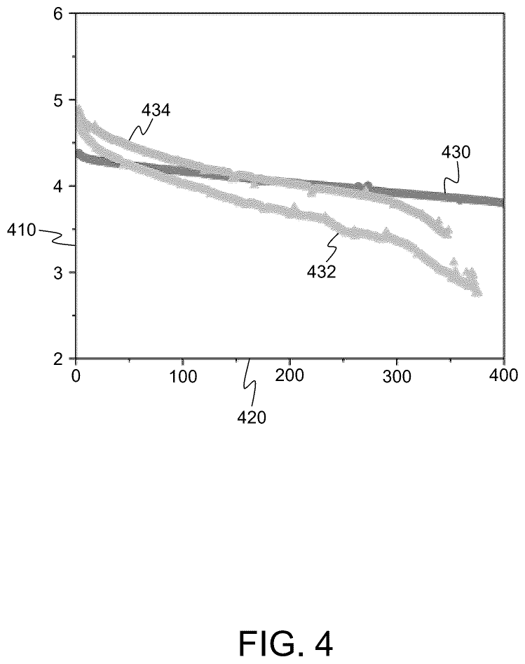

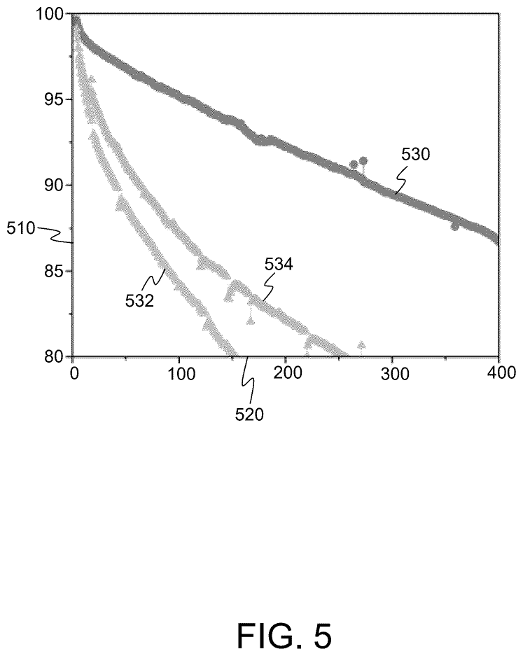

FIGS. 4 and 5 include graphs showing discharge capacity (mAh/cm²; axis 410 in FIG. 4) and discharge capacity retention (%; axis 510 in FIG. 5) for the coin cells relative to cycle number (axis 420 in FIG. 4 and axis 520 in FIG. 5). In FIG. 4, the electrolyte included: 1.0 wt. % TTMSPi and 1.0 wt. % LiPO₂F₂ (labeled 430); 2.0 wt. % TTMSPi and 1.0 wt. % LiPO₂F₂ (labeled 432); and 3.0 wt. % TTMSPi and 1.0 wt. % LiPO₂F₂ (labeled 434). In FIG. 5, the electrolyte included: 1.0 wt. % TTMSPi and 1.0 wt. % LiPO₂F₂ (labeled 430); 2.0 wt. % TTMSPi and 1.0 wt. % LiPO₂F₂ (labeled 532); and 3.0 wt. % TTMSPi and 1.0 wt. % LiPO₂F₂ (labeled 534). The results of these experiments indicated that additions of TTMSPi in excess of about 1.0 wt. % produced diminishing results, that is, showed a decrease in discharge capacity retention.

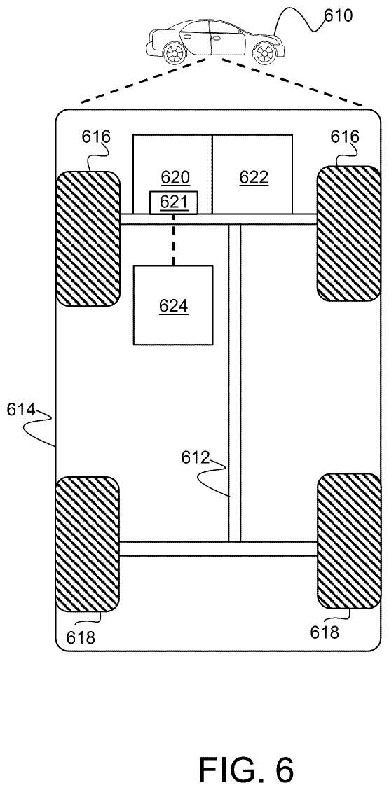

With reference now to FIG. 6, a vehicle 610 is provided according to an exemplary embodiment. In certain examples, the vehicle 610 comprises an automobile. In various examples, the vehicle 610 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain examples.

As depicted in FIG. 6, the exemplary vehicle 610 generally includes a chassis 612, a body 614, front wheels 616, and rear wheels 618. The body 614 is arranged on the chassis 612 and substantially encloses components of the vehicle 610. The body 614 and the chassis 612 may jointly form a frame. The wheels 616-618 are each rotationally coupled to the chassis 612 near a respective corner of the body 614.

The vehicle 610 further includes a propulsion system 620, a transmission system 622, and at least one lithium-ion battery 624. The propulsion system 620 includes an electric motor 621 or a hybrid electric motor and combustion engine. The transmission system 622 is configured to transmit power from the propulsion system 620 to the wheels 616-618 according to selectable speed ratios. According to various examples, the transmission system 622 may include a step-ratio automatic transmission, a continuously-variable transmission, or other appropriate transmission. The propulsion system 620 receives electrical power from the at least one lithium-ion battery 624 suitable for powering operation of the propulsion system 620 and/or components thereof (e.g., the electric motor 621). The lithium-ion battery 624 may include one or more lithium-ion electrochemical cells such as the electrochemical cell 20 of FIG. 1.

The systems and methods disclosed herein provide various benefits over certain existing systems and methods. For example, electrolytes that include two or more of the electrolyte additives disclosed herein may provide a significant reduction in gas generation during cycling of a cell. In some examples, such electrolytes may have improved cycle life at high voltage with, for example, more than 85% discharge capacity retention for 400 cycles or more.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An electrode for an electrochemical cell that cycles lithium ions, the electrode comprising:
a lithium-rich, manganese-rich layered oxide electroactive material; and
an electrolyte including two or more electrolyte additives selected from the group consisting of: a lithium salt additive, a fluorinated ester-based additive, a silicon-based additive, and combinations thereof.

2. The electrode of claim 1, wherein the electrode comprises from about 0.001 wt. % to about 10 wt. % of each of the two or more electrolyte additives.

3. The electrode of claim 1, wherein the electrolyte includes diethyl carbonate and fluoroethylene carbonate.

4. The electrode of claim 1, wherein the two or more electrolyte additives, in combination, include phosphorus, silicon, and fluorine.

5. The electrode of claim 1, wherein the two or more electrolyte additives include tris(trimethylsilyl) phosphite (TTMSPi) and lithium difluorophosphate (LiPO₂F₂).

6. The electrode of claim 1, wherein the two or more electrolyte additives include 2,2,2-trifluoroethyl acetate (TFEA), lithium bis(trifluoromethanesulfonyl)imide (LiTFSI), tris(trimethylsilyl) phosphite (TTMSPi), and lithium difluorophosphate (LiPO₂F₂).

7. The electrode of claim 6, wherein the two or more electrolyte additives include 0.1 to 5.0 wt. % TFEA, 0.1 to 5.0 wt. % LiTFSI, 0.1 to 5.0 wt. % TTMSPi, and 0.1 to 5.0 wt. % LiPO₂F₂.

8. An electrochemical cell that cycles lithium ions, the electrochemical cell comprising:
a first electrode having a first polarity and comprising:
a positive, lithium-rich, manganese-rich layered oxide electroactive material; and
an electrolyte including two or more electrolyte additives selected form the group consisting of: a lithium salt additive, a fluorinated ester-based additive, a silicon-based additive, and combinations thereof;
a second electrode having a second polarity opposite from the first polarity and comprising a negative electroactive material; and
a separating layer disposed between the first electrode and the second electrode.

9. The electrochemical cell of claim 8, wherein the first electrode comprises greater than or equal to about 0.001 wt. % to less than or equal to about 10 wt. % of each of the two or more electrolyte additives.

10. The electrochemical cell of claim 8, wherein the electrolyte includes diethyl carbonate and fluoroethylene carbonate.

11. The electrochemical cell of claim 8, wherein the two or more electrolyte additives, in combination, include phosphorus, silicon, and fluorine.

12. The electrochemical cell of claim 8, wherein the two or more electrolyte additives include tris(trimethylsilyl) phosphite (TTMSPi) and lithium difluorophosphate (LiPO₂F₂).

13. The electrochemical cell of claim 8, wherein the two or more electrolyte additives include 2,2,2-trifluoroethyl acetate (TFEA), lithium bis(trifluoromethanesulfonyl)imide (LiTFSI), tris(trimethylsilyl) phosphite (TTMSPi), and lithium difluorophosphate (LiPO₂F₂).

14. The electrochemical cell of claim 13, wherein the two or more electrolyte additives include 0.1 to 5.0 wt. % TFEA, 0.1 to 5.0 wt. % LiTFSI, 0.1 to 5.0 wt. % TTMSPi, and 0.1 to 5.0 wt. % LiPO₂F₂.

15. The electrochemical cell of claim 14, wherein the electrolyte includes diethyl carbonate and fluoroethylene carbonate, wherein the positive, lithium-rich, manganese-rich layered oxide electroactive material is represented by xLi₂MnO₃·(1−x)LiMO₂ where M is a transition metal selected from the group consisting of: nickel (Ni), manganese (Mn), cobalt (Co), aluminum (Al), iron (Fe), and combinations thereof, where 0.01≤x≤0.99.

16. The electrochemical cell of claim 8, wherein at least one of the two or more electrolyte additives includes at least one fluorinated ester-based additive.

17. A vehicle, comprising:
a propulsion system that includes an electric motor; and
an electrochemical cell that cycles lithium ions and is configured to provide electrical power to the electric motor, wherein the electrochemical cell comprises:
a first electrode having a first polarity and comprising:
a positive, lithium-rich, manganese-rich layered oxide electroactive material represented by xLi₂MnO₃·(1−x)LiMO₂ where M is a transition metal selected from the group consisting of: nickel (Ni), manganese (Mn), cobalt (Co), aluminum (Al), iron (Fe), and combinations thereof, and where 0.01≤x≤0.99; and
an electrolyte including two or more electrolyte additives selected form the group consisting of: a lithium salt additive, a fluorinated ester-based additive, a silicon-based additive, and combinations thereof, wherein the electrolyte comprises greater than or equal to about 0.001 wt. % to less than or equal to about 10 wt. % of each of the two or more electrolyte additives;
a second electrode having a second polarity opposite from the first polarity and comprising a negative electroactive material; and
a separating layer disposed between the first electrode and the second electrode.

18. The vehicle of claim 17, wherein the two or more electrolyte additives include tris(trimethylsilyl) phosphite (TTMSPi) and lithium difluorophosphate (LiPO₂F₂).

19. The vehicle of claim 17, wherein the two or more electrolyte additives include 2,2,2-trifluoroethyl acetate (TFEA), lithium bis(trifluoromethanesulfonyl)imide (LiTFSI), tris(trimethylsilyl) phosphite (TTMSPi), and lithium difluorophosphate (LiPO₂F₂).

20. The vehicle of claim 19, wherein the two or more electrolyte additives include 0.1 to 5.0 wt. % TFEA, 0.1 to 5.0 wt. % LiTFSI, 0.1 to 5.0 wt. % TTMSPi, and 0.1 to 5.0 wt. % LiPO₂F₂.
